(19) United States
(12) Patent Application Publication
(10) Pub. No.: US 2004/0107136 A1
(43) Pub. Date: Jun. 3, 2004

(54) Interactive electronic commerce system facilitating management of advertising, promotion and information interchange messages

(76) Inventors: Frank Robert Nemirofsky, Alamo, CA (US); Larry A. Lincoln, Milpitas, CA (US)

Correspondence Address: MARK J. SPOLYAR, 38 FOUNTAIN ST., SAN FRANCISCO, CA, 94114, US

(21) Appl. No.: 10/618,569

(22) Filed: Jul. 11, 2003

Related U.S. Application Data
(60) Provisional application No. 60/395,577, filed on Jul. 12, 2002.

(51) Int. Cl. G06F 17/60

(52) U.S. Cl. 705/14

(57) ABSTRACT

Methods and systems enabling an interactive electronic commerce system that facilitates dissemination and management tasks associated with advertisements and other advertising, promotion or information interchange messages, such as coupon offers and sales announcements. In one embodiment, the present invention further provides advertisers the ability to assess the correlation between the broadcast (or other delivery) of an advertisement and user activity related to the advertisement, such as a purchase or inquiry.

### CROSS-REFERENCE RELATED APPLICATIONS

The present application claims priority from U.S. provisional patent application Ser. No. 60/395,577 filed Jul. 12, 2002 and entitled “Interactive Electronic Commerce System Facilitating Management of Advertising, Promotion and Information Interchange Messages.”

### FIELD OF THE INVENTION

The present invention relates to electronic commerce and, more particularly, to methods, apparatuses and systems facilitating the dissemination and management of commercial offers and other advertising, promotion and information interchange messages.

### BACKGROUND OF THE INVENTION

The widespread use of open computer networks and, in particular, the Internet has resulted in the explosive growth of electronic commerce. The Internet allows users access to a vast array of on-line merchants offering myriad products and services and, conversely, allows on-line merchants to inexpensively communicate with users. Users are often times overloaded with information and choices as to where to shop and what to buy. Indeed, users of computer networks such as the Internet are often bombarded with commercial advertisements and offers, for most of which a particular user has little or no interest. In significant part, these random, unsolicited offers, often in the form of e-mails (known as “SPAM”), result from the authorized or unauthorized sale of customer data from one on-line merchant or service provider to another. Except for the emergence of the Internet, which is essentially unused by the majority of consumers to conduct their daily commerce, there have been few significant improvements in the way consumers conduct daily or regular financial transactions for many years. There is demonstrable, pent-up demand from consumers, financial services, merchants, the media, advertisers, cellular services, device manufacturers, data service providers and others seeking a means for the public to securely, efficiently, simply, and enjoyably conduct daily transactions and information interchange. In light of the foregoing, a need exists for methods and systems that allow users to receive and manage advertising, promotion and information interchange messages in which they are likely to be interested. Embodiments of the present invention substantially fulfill this need.

### SUMMARY OF THE INVENTION

The present invention provides methods and systems enabling an interactive electronic commerce system that facilitates dissemination and management tasks associated with advertisements and other advertising, promotion or information interchange messages, such as coupon offers and sales announcements. In one embodiment, the present invention further provides advertisers the ability to assess the correlation between the broadcast (or other delivery) of an advertisement and user activity related to the advertisement, such as a purchase or inquiry.

According to one embodiment of the present invention, users, using a cell phone/PDA, UDA ( Universal digital assistant) or personal computer, access a commerce management system to input a product or service identifier conveyed in an advertisement or other advertising, promotion and information interchange message, such as a coupon offer. The commerce management system allows the user to order the product or service and/or manage the advertising, promotion or information interchange message by specifying the conditions under which the user wishes to receive information about the same product or service. For example, the condition could be a threshold period of time, a price reduction or sale. The commerce management system is operative to detect the occurrence of the specified condition and deliver a message related to the product or service to the user. In one embodiment, the commerce management system also allows advertisers to assess through a data mining process the correlation between broadcasts or other dissemination of advertising content and the conversion of users.

In another embodiment, the present invention provides methods, apparatuses and systems that deliver tailored advertising messages to users concurrently with advertising or content in television or radio broadcasts.

### DESCRIPTION OF THE DRAWINGS

FIG. 1 is a functional block diagram illustrating an embodiment of the system of the present invention.

FIG. 2 is a functional block diagram setting forth an advertisement delivery system operating in connection with a television broadcast according to one embodiment of the present invention.

### DETAILED DESCRIPTION OF PREFERRED EMBODIMENT(S)

I. Operating Environment

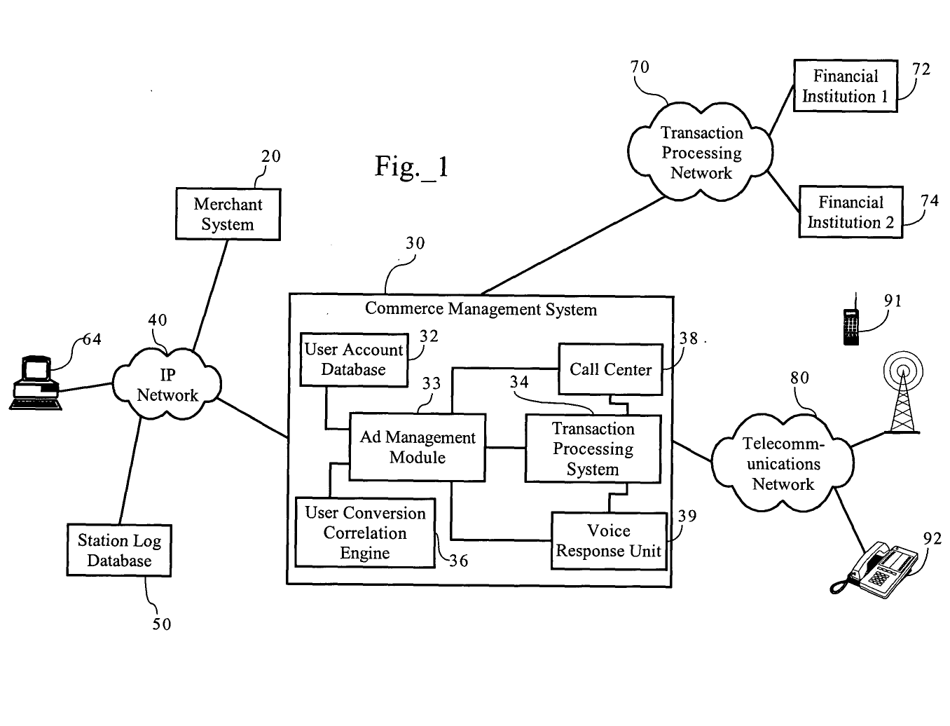

FIG. 1 illustrates an electronic commerce system according to one embodiment of the present invention. As FIG. 1 illustrates, the electronic commerce system operates in connection with a computer network environment including, in one embodiment, an IP network 40, at least one telephone network 80, and at least one transaction processing network 70. Computer network 40 can be any suitable computer network, including an open, wide-area network, such as the Internet. In addition, computer network 40 can comprise an electronic network, an optical network, a wireless network, and/or a combination thereof. In addition, embodiments of the present invention operate in connection with a telecommunications network 80 (e.g., a land-based telephone network, a wireless telephone network, and/or a combination thereof). As FIG. 1 shows, one embodiment of the present invention operates in a computer network environment comprising commerce management system 30, station log database 50, at least one merchant system 20, at least one network access device, such as client computer 64, at least one transaction processing network 70 (e.g., Automated Clearing House (ACH) Network, credit card network), and at least one financial institution 72,74, such as a bank.

A. Commerce Management System

Commerce management system 30 facilitates the management and dissemination of advertising, promotion and information interchange messages, such as advertisements and other offers. As FIG. 1 shows, commerce management system 30, in one embodiment, comprises user account database 32, ad management module 33, transaction processing system 34, user conversion correlation engine 36, call center 38, and voice response unit 39. User account database 32 stores user account information for a plurality of users. Ad management module 33 is operative to deliver advertising, promotion and information interchange messages to users based upon the occurrence of at least one condition. Transaction processing system 34 is operative to receive product orders from users and process payment transactions.

Call center 38 is a center comprising at least one call station assisting a live agent to handle calls from users at telephones 91, 92. In one embodiment, call center 38 includes call center software enabling the logging of calls and facilitating the recording of interaction data related to the calls. In one embodiment, the call center software also includes functionality providing content to assist call center agents in helping users to order products or acquire more information about advertised products. Interactive voice response system 39 is a telephone-based interface allowing users at telephones 91, 92 to receive and transmit data over telecommunications network 80. In one embodiment, interactive voice response system 39 includes a DTMF receiver that detects tones from telephones 91, 92 and resolves the number or character associated with such tones. In another embodiment, interactive voice response system 39 includes speech recognition functionality allowing users to speak commands. In another embodiment, interactive voice response system 39 includes both DTMF and speech recognition functionality. In one embodiment, call center 38 and interactive voice response system 39 further include automatic number identification (ANI) functionality, allowing identification of telephone numbers associated with incoming calls. Such telephone numbers are used in one embodiment to identify users and retrieve user account information from user account database 32. Additionally, in one embodiment, interactive voice response system 39 allows users to transfer to call center 38 in order to speak with a live agent.

User account database 54 stores information related to at least one user account. Such user account information includes a user account identification, name, address, e-mail address, as well as system settings, preferences, demographic information and behavioral information obtained through monitoring a user's use of the system described herein. For example, user account database 54 may store information related to the user's age, marital status, children, cars owned, income level, etc. User account database 54 may also store information gleaned from the use of the electronic commerce system described herein, such as a log of purchase transactions, etc. User account database 54 also stores information related to at least one financial account which can be used to pay for goods and services ordered via commerce management system 30.

In one embodiment, commerce management system 30 operates independently from, but in connection with at least one merchant system 20. According to one embodiment, commerce management system 30 receives data describing at least one product or service and a predetermined product/service identifier. In one embodiment, ad management module 33 stores the data in a database for later use. Ad management module 33 is also operative to receive at least one condition from a user indicating the circumstances under which the user desires to receive messages relating to a particular product or service. As described more fully below, ad management module 33 also receives update product/services data from merchant system and, as to an individual user, is operative to determine whether a message related to the product/services should be delivered to the user based on the conditions specified by him/her.

B. Transaction Processing Networks

Payment transaction processing network 70 supports a non-cash payment mechanism, such as credit card, debit card, and Automated Clearing House (ACH) transaction processing networks. According to one embodiment, the transaction processing networks can be a credit card or debit card transaction processing network, such as VISA®, MASTERCARD®, DISCOVER®, or AMERICAN EXPRESS®. In one embodiment, the transaction processing networks enable users, using universal digital assistant 90, to provide a non-cash method of payment to a merchant system 50.

C. Financial Institutions

Banks 72 and 74 are financial institutions at which users maintain checking and other financial accounts, such as savings accounts, money market accounts, credit and/or debit card accounts, etc. Although, in the illustrative embodiments described herein, one bank corresponds to each user, each user can have a plurality of bank accounts at one to a plurality of financial institutions. For example, a user may have a checking account at one financial institution and a credit card account with a different financial institution.

D. Client Computer

To facilitate initiation and maintenance of user accounts, users may access UDA application site 50 via network access devices over computer network 40 to manage their respective user accounts. In one embodiment, a network access device is a browser executed on a personal computer 64, or a browser executed on a network computer 64. One embodiment of present invention is implemented using page-based interfaces transmitted to client computer 64 having a browser and a connection to computer network 40. Client computer 64 can be any computer, special-purpose computing device, or any other suitable device for performing the required functionality. In one embodiment, client computer 64 includes at least one processor, a data storage system (including volatile and non-volatile media), a keyboard, a display, at least one input device and at least one output device. In one embodiment, the user's computer is connected to the Internet via a modem dial-up connection or through a network line. Such communication, however, could also be wireless. In addition, although embodiments of the system are described as working in conjunction with a browser, any suitable device or application for receiving, displaying and transmitting data over a computer network can be used in the present invention. In one embodiment, the browser implemented on client computer 64 supports the SSL (“Secure Sockets Layer”) protocol, the S-HTTP (“Secure HTTP”) protocol, or any other similar protocol for transmitting confidential or private information over an open computer network. Users are individuals or other legal entities having the capacity to possess financial accounts, such as corporations, partnerships, non-profit organizations, trusts, and the like.

II. Operation

A. Registration and Establishment of User Accounts

According to one embodiment, users register with commerce management system 30 and establish a user account. In one embodiment, users provide demographic and other user profile data. User profile data, in one form, includes, but is not limited to, demographic data, personal interest data, personal identifying data, and transaction history data, as well as user profile data derived from the foregoing through techniques such as collaborative filtering and clickstream analysis. For example, users provide such information as hobbies, recreational activities, profession, gender, age, etc. In one embodiment, users also specify a preferred delivery mode for messages (e.g., e-mail, electronic coupon, hard-copy coupon, SMS message, etc.). Users, in one embodiment, further provide financial account data, such as credit card or debit card account information allowing commerce management system 30 to process payment transactions for products and services ordered using the system. Subsequent to registration, users may, in one embodiment, access their accounts to update user profile and permission set data.

B. Receipt and Management of Advertising, Promotion or Information Interchange Messages

According to one embodiment of the present invention, advertisements or other advertising, promotion and information interchange content including a product/service identifier are disseminated to users. Such advertising, promotion and information interchange content can be provided to users in a variety of ways. For example, the advertisements may be disseminated in television and/or radio broadcasts. The advertisements may also be distributed in print media. In addition, the advertisements may also be distributed over the Internet as emails or transmitted in banner advertisements on web pages. In each instance, the advertisement or advertising, promotion and information interchange content includes at least one product/service identifier that a user may use to identify the product in connection with a purchase or a request for more information about the product/service. Suitable product identifiers may be a number string or an alpha-numeric string.

A user then accesses commerce management system 30 and enters at least one product/service identifier to purchase the product/service, receive more information about it, and/or specify the conditions under which the user would like to receive information about the product/service in the future. For example, a user viewing a television advertisement including a product identifier can use his or her telephone 91 or 92 to access call center 38 and/or voice response system 39 of commerce management system 30. In one embodiment, the user provides an account identification and a password for authentication purposes. In one embodiment, ANI functionality, discussed above, allows call center 38 and/or voice response system 39 to automatically identify the user's telephone number and access user account database 32 to retrieve user account data. After authentication (as for example by prompting the user for, and receiving, a password), the user is prompted to enter a product/service identifier.

As discussed above, the user may perform a variety of actions with respect to the product/service identifier. In one embodiment, the user may purchase the product or service. In one embodiment, transaction processing system 34, when a user wishes to purchase a product/service, is operative to retrieve financial account data from user account database 32 and process a payment transaction over transaction processing network 70. For example, if the financial account is a credit card account, transaction processing system 34 may transmit an authorization request to a financial institution 72 or 74 over transaction processing network. If the purchase is authorized, transaction processing system 34 completes the purchase transaction. In one embodiment, transaction processing system 34 transinits a completed order to merchant system 20 for fulfillment. Settlement of credit or debit card transactions can be accomplished in a conventional manner.

Alternatively, the user may elect to receive additional information about the product/service corresponding to the product/service identifier. In one embodiment, ad management module 33 returns product/service information associated with the product/service identifier in response to the request. In one embodiment, transaction processing system 30 delivers the product information according to the preferred delivery mode specified in the user's account.

In addition, the user may specify the conditions under which the user would like to receive additional information about the product/service. For example, the user may specify that he would like to receive more information about the product or service after a three-month period or if the advertised price falls below a threshold. In one embodiment, transaction processing system 30 allows the user to select from a plurality of predefined conditions, such as a time period, price drop, sales notice, product discontinuation alert, low inventory notice, etc. After the user specifies the conditions, ad management module 33 stores the product identifier and condition data in association with the user's account.

In addition, commerce management system 30 includes functionality that logs activity related to advertisements supported by the system, such as purchase transactions and product inquiries. As discussed in more detail below, this activity log can be used in a variety of manners, for example, to assess the correlation between dissemination of an advertisement and user activity associated with the advertisement. Furthermore, users can access the functionality of commerce management system 30 using any suitable means, such as client computer 64, wireless telephone 91, POTS telephone 92, or any other suitable device, such as a WAP-enabled device, such as a WAP phone or Personal Digital Assistant (PDA).

C. Processing of Condition Data and Deliver of Product/Service Information

In one embodiment, commerce management system 30 receives subsequent product/service information from merchant system 20 and detects, as to a given user account, whether a condition controlling delivery of information for a particular product or service has occurred. In one embodiment, ad management module 33, in a background process, processes newly received product information against the delivery condition data stored in user account database 32. If any delivery conditions are met, transaction processing system 30 transmits the product/service information according to the delivery mode originally specified by the user. In one embodiment, merchant system 20 transmits product/service information in an XML file according to a predetermined Document-Type-Definition allowing ad management module 33 to parse the XML file and process the information against the delivery conditions.

D. Transmission of Advertising Messages Concurrently with Television or Radio Broadcasts

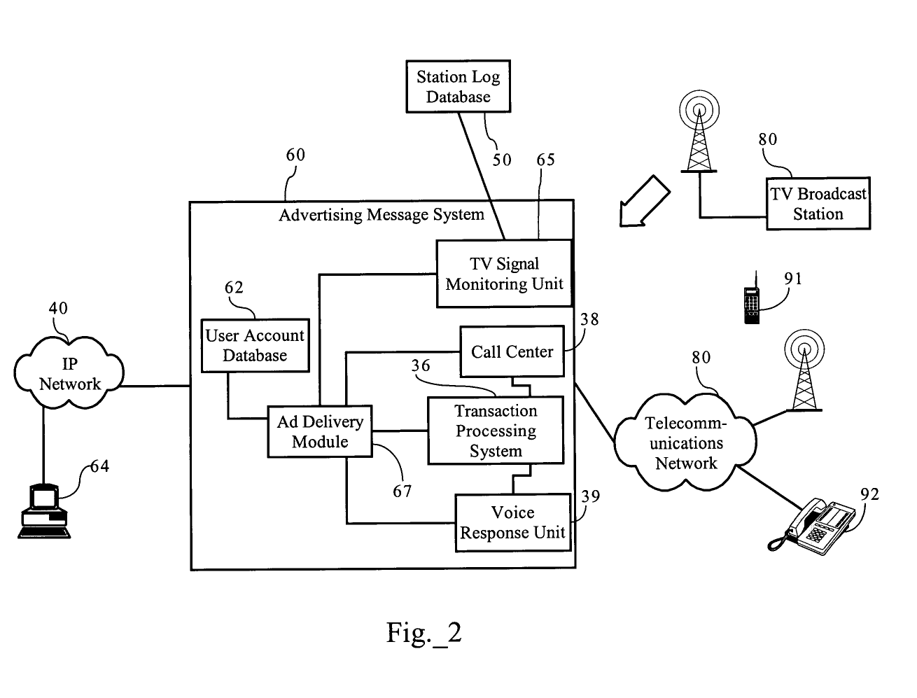

FIG. 2 illustrates a system, according to one embodiment of the present invention, that delivers tailored advertising messages to individual users concurrently with and in response to advertising or content in television broadcasts. As FIG. 2 illustrates, advertising message system 60 includes user account database 32, ad delivery module 67, TV broadcast signal monitoring unit 65, transaction processing system 36, call center 38 and voice response unit 39. TV broadcast signal monitoring unit 65 is operative to monitor at least one television broadcast signal and detect a message code in the broadcast signal. Ad delivery module 67 is operative to transmit messages to users based upon the detection of message codes, as described more fully below. User account database 32, transaction processing system 36, call center 38 and voice response unit 39 are described above.

According to one embodiment, TV broadcast station 80 broadcasts television programming, such as regular content or advertising, to which one to a plurality of television sets are tuned. In one embodiment, a message code is embedded at selected points in the television signal broadcast from station 80. The message code can be embedded according to a variety of methods. For example, the message code can be transmitted in the Vertical Blanking Interval (VBI) of the television signal or can be encoded either subliminally or overtly in any of the known or future video streams (including digital, NTSC, SECAM or PAL) or in the side-band frequencies associated with the television signal. Of course, the present invention can operate in connection with a variety of broadcast stations or other means of video distribution, such as cable broadcast stations, satellite, closed-cell television, etc.

As the programming is broadcast, users register with advertising message system 60 to receive advertising and information interchange messages concurrently with the programming displayed on their respective television sets. For example, a user may dial into call center 38, provide a user name and password to authenticate himself and access his user account. Once authenticated, the user may register to receive advertising and information interchange messages concurrently with the programming currently being broadcast. Alternatively, the user may access his user account using voice recognition unit 39. In another embodiment, a user may register over computer network 40 using network access device 64. After the user is registered, his user account identification is transmitted to ad delivery module 67 which adds the user's account identification to its current configuration.

TV signal monitoring unit 65 includes at least one tuning circuit that receives the television signal broadcast from station 80. TV signal monitoring unit 65 further includes functionality operative to detect message codes in the broadcast signal and to transmit such message codes to ad delivery module 67. In one embodiment, TV signal monitoring unit 65 is operative to detect message codes contained in the VBI of the television signal. In one embodiment, monitoring unit 65 compares codes it detects against a predefined list of message codes to determine whether a valid message code has been detected. If so, monitoring unit 65 transmits the message code to ad delivery module 67.

Ad delivery module 67, in response to the detection of a valid message code, is operative to deliver an advertising or other message to users currently registered with the system. In one embodiment, when the user registers, advertising message system 60 prompts the user for a message delivery mode (e.g., email, voice message, SMS message, instant message, etc.) to be used to delivery the advertising message. In one embodiment, user account database 32 includes a default delivery mode field whose value is used if no delivery mode is specified. As discussed above, as users register, their corresponding user account identifications, delivery mode/channel and corresponding delivery mode address (e.g., email address, phone number, etc.) is stored in a user list. When a message code is detected, ad delivery module 67 scans an advertising message database to locate the advertising message associated with the message code, and loops through the user list to deliver the advertising message to the users. Accordingly, and in one embodiment, the present invention allows a user to watch television programming and concurrently receive an advertising or other message via a second communication mode or channel. For example, while the user is watching a fast food commercial, ad delivery module may transmit an email including an electronic coupon to the user.

According to one embodiment, the advertising message can be tailored to individual user characteristics based on demographic and other information stored in user account database 32. For example, in one embodiment, ad delivery module 67 includes an advertising message database that stores at least two advertising messages and a message delivery rule set in association with a message code. In one embodiment, as ad delivery module 67 steps through the user list, it processes the user's information in user account database against the message delivery rule set to select an advertising message associated with the message code to transmit to the user. If an advertising message is found, ad delivery module 67 transmits the advertising message to the user according to the specified delivery mode. Ad delivery module 67 can also perform other functions, such as logging the message code and/or advertising message in association with the user's account.

E. Correlation of Ad Broadcast and User Conversion

As discussed above, commerce management system 30 or advertising message system 60, in one embodiment, is operative to generate reports allowing for assessment of the correlation between the timing of advertisement dissemination and user activity related to the advertisement, such as a purchase or product inquiry. For example, and in one embodiment, commerce management system 30 is operative to access station log database 50 to retrieve the broadcast times of a particular advertisement including a product identifier maintained by the system. Station log database 50 maintains a log/schedule of the programming broadcast on television and/or radio stations for at least one geographic area. In one embodiment, station log database 50 is essentially a copy of the station logs maintained by a station traffic manager. User conversion correlation engine 36 then processes this station log data against log activity data corresponding to the geographic area associated with each station log to generate reports characterizing the correlation between dissemination of an advertisement using a given broadcast medium and user activity associated with the advertisement. Such reports allow advertisers the ability to assess the impact of the advertisement and or the media over which it is disseminated on the activity of users of commerce management system 30.

In one embodiment, the station log database 50 is maintained in real-time in response to what was actually broadcast by broadcast station 80. In one embodiment, station log database 50 is populated by TV signal monitoring unit 65 which, in addition to message codes, monitors for advertising and content identifiers embedded in the VBI of the television signal broadcast by station 80 and records the advertising and content identifiers and the times such identifiers were detected in station log database 50. As discussed above, the broadcast activity as maintained by station log database 50 can be correlated with user activity (e.g., purchase transactions or inquiries) associated with the advertisement or content.

Lastly, the present invention has been described with reference to specific embodiments. Other embodiments of the present invention will be apparent to one of ordinary skill in the art. It is, therefore, intended that the scope of the invention not be limited to the embodiments described above.

What is claimed is:

1. An interactive electronic commerce system enabling selective delivery of commerce-related messages, comprising
a user account database storing user account information associated with a plurality of users;
a message database storing at least one message in association with a product identifier;
a message management module operative to
receive, from a user, a product identifier and at least one condition under which the user desires to receive information associated with the product identifier;
store the product identifier and the at least one condition in the user account database in association with the user account corresponding to the user;
receive, and store in the message database, at least one message and a product identifier associated with the message;
scan the user account database to determine whether the at least one message satisfies the conditions imposed by users;
deliver the message as to all users where the imposed conditions are satisfied.

2. The system of claim 1 further comprising a transaction processing system operative to receive product orders from users and process payment transactions.

3. The system of claim 1 further comprising a call center comprising at least one call station assisting a live agent to handle calls from users.

4. The system of claim 1 further comprising an interactive voice response system to receive and transmit data over a telecommunications network, the interactive voice response system providing the interface by which users access the message management module.

5. The system of claim 4 wherein the interactive voice response system includes automatic number identification (ANI) functionality, allowing identification of telephone numbers associated with incoming calls, and wherein identified telephone numbers are used to identify users and retrieve user account information from the user account database.

6. The system of claim 1 wherein the at least one message is an electronic coupon.

7. A method enabling conditional delivery of commerce-related information, comprising
receiving from a user an identification of a product or service, wherein the product or service is the subject of a broadcast;
receiving from the user at least one condition under which the user desires to receive additional information relating to the product or service;
receiving a user identification corresponding to the user;
storing the identification of the product or service and the at least one condition in association with the user identification;
after receiving additional information relating to the product or service, assessing whether the at least one condition is satisfied; and
conditionally providing the additional information to the user, if the at least one condition is satisfied.

8. A system enabling delivery of promotional messages concurrently with a broadcast, comprising
a user registration module operatively connected to a telecommunications network, wherein the user registration module is operative to
receive calls from users, and
register users on an active user list;
a message database storing at least one message in association with a message code;
a broadcast signal monitoring unit operative to detect message codes in a broadcast signal,
a message delivery module operative to
upon detection of a message code by the broadcast signal monitoring unit, retrieve a message corresponding to the message code in the message database, and
distribute the message to the users on the active user list.

9. The system of claim 8 wherein the broadcast signal is a television signal.

10. The system of claim 8 wherein the broadcast signal is a radio signal.

11. The system of claim 8 wherein the message is an electronic coupon.

12. The system of claim 8 further comprising a user account database storing user account identifiers in association with at least one message delivery mode preference, and wherein the ad delivery module is operative to deliver the message to each user using the delivery mode specified in a corresponding user account.
